(19) United States
(12) Patent Application Publication
(10) Pub. No.: US 2026/0247323 A1
(43) Pub. Date: Aug. 20, 2026

(54) UE LOCATION REPRESENTED BY IAB-MT USER LOCATION

(71) Applicant: Telefonaktiebolaget LM Ericsson (publ), Stockholm (SE)

(72) Inventors: Paul Schliwa-Bertling, Ljungsbro (SE); Qian Chen, Molndal (SE); Filip Barac, Huddinge (SE)

(21) Appl. No.: 18/851,744

(22) PCT Filed: Mar. 28, 2023
(86) PCT No.: PCT/IB2023/053095

§ 371 Date: Sep. 27, 2024

Related U.S. Application Data
(60) Provisional application No. 63/324,510, filed on Mar. 28, 2022.

(51) Int. Cl. H04W 64/00; H04W 60/04

(52) U.S. Cl. CPC H04W 64/00; H04W 60/04

(57) ABSTRACT

Methods and systems are described for the tracking and reporting of ULI of UEs connected to an IAB-MT. One or more UEs can be connected to an IAB-MT, which may move from one network node to another. As the IAB-MT changes nodes it may be difficult or use heavy resources and bandwidth for the network to track ULI for all the UEs served by the IAB-MT. A location of the IAB-MT can be used to form all or a portion of the ULI of the UEs. Cell IDs or TA (tracking areas) of either the IAB-MT or the UEs can be used to form parts of the ULI.

### CROSS REFERENCE TO RELATED INFORMATION

This application claims the benefit of United States of America priority application No. 63/324,510 filed on Mar. 28, 2022, titled “UE Location Represented By IAB-MT User Location.”

### TECHNICAL FIELD

The present disclosure generally relates to the technical field of wireless communications and more particularly to location determination and reporting.

### BACKGROUND

In 5GS, IAB (integrated access and backhaul) architecture is supported as specified in TS 23.501 clause 5.35. An IAB-node can be connected to the 5G system via an IAB-donor node first. Then UEs (user equipments) can connect to IAB-nodes which provide the access to the 5G system.

There currently exist certain challenges. In the current solutions, there is no mobility support for the IAB-node (e.g., an IAB-node moves from one IAB-donor node to another IAB-donor node with UEs connected to the IAB-node).

In RAN rel-17 work, some work has been done to support the IAB inter-CU (central unit) topology redundancy, IAB inter-CU topology adaptation and IAB inter-CU backhaul RLF (radio link failure) recovery as documented in draft CR R3-222919. However, there is still no support of full mobility of an IAB-node from one IAB-donor node to another IAB-donor node. SA2 has initiated a study for vehicle mounted relay (e.g., an IAB-node in a bus moves from one area covered by one IAB-donor node to another area covered by another IAB-donor node) based on IAB-architecture and several Key Issues are currently defined in TR 23.700-05 v 0.1.0.

For example, Key Issue 3 is related to IAB-node mobility with connected UEs. Key Issue 6 is related to how the user location (e.g., cell or TAI (tracking area identity)) of the UE connected to the IAB-node shall be handled.

### SUMMARY

One embodiment under the present disclosure comprises a method performed by an IAB donor for reporting ULI of UEs connected to an IAB-MT that is connected to the IAB donor. The method includes determining a location of the IAB-MT; and reporting an indication of a ULI of the one or more UEs, connected to the IAB-MT, to a first network node, wherein the ULI comprises the location of the IAB-MT.

Another embodiment under the present disclosure is a method performed by an IAB-MT for reporting ULI of UEs. Steps include connecting to a network node; and determining a location of the IAB-MT. It further includes reporting an indication of ULI to the first network node, wherein the ULI comprises the location.

A further embodiment is a method performed by a core network for tracking ULI of one or more UEs. Steps of the method include receiving a location of an IAB-MT from a network node connected to the IAB-MT, wherein the IAB-MT is connected to the one or more UEs; and storing a ULI for the one or more UEs, wherein the ULI comprises the location of the IAB-MT.

Another embodiment comprises a network node for reporting and/or tracking ULI of one or more UEs. The network node comprises processing circuitry configured to perform any of the steps of any the previously described embodiments above; and power supply circuitry configured to supply power to the processing circuitry.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 displays a system embodiment under the present disclosure;

FIG. 2 shows a sample IE embodiment under the present disclosure;

FIG. 3 shows a sample UserLocation embodiment of the disclosure;

FIG. 4 shows a sample NrLocation embodiment of the disclosure;

FIG. 5 displays a system embodiment under the present disclosure;

FIG. 6 shows a flow-chart of a method embodiment under the present disclosure;

FIG. 7 shows a flow-chart of a method embodiment under the present disclosure;

FIG. 8 shows a flow-chart of a method embodiment under the present disclosure;

FIG. 9 shows a schematic of a communication system embodiment under the present disclosure;

FIG. 10 shows a schematic of a user equipment embodiment under the present disclosure;

FIG. 11 shows a schematic of a network node embodiment under the present disclosure;

FIG. 12 shows a schematic of a host embodiment under the present disclosure;

FIG. 13 shows a schematic of a virtualization environment embodiment under the present disclosure; and

FIG. 14 shows a schematic representation of an embodiment of communication amongst nodes, hosts, and user equipment under the present disclosure.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

Certain aspects of the disclosure and their embodiments may provide solutions to the challenges identified and may provide one or more of the following technical advantages. In addition to the user location that is formulated for the UE connected to the IAB-node, additional user location information of the IAB-MT (IAB mobile termination) can be added to the user location information (ULI). It should be noted, the IAB-MT is one part of the IAB-node. The term “IAB-MT” is a RAN (Radio Access Network) specification term, which is equal to an IAB-UE, which is a SA (Stand Alone) specification term. Embodiments of the disclosure can provide a solution to support a ULI that is related to a geographic area, even if the user location of the UE may not be linked to a geographic area. Under certain embodiments, reusing the user location of the IAB-MT as additional user location for the UE connected to the IAB-node provides simple logic to link the UE location to a geographic area.

Some of the embodiments contemplated herein will now be described more fully with reference to the accompanying drawings. Embodiments are provided by way of example to convey the scope of the subject matter to those skilled in the art.

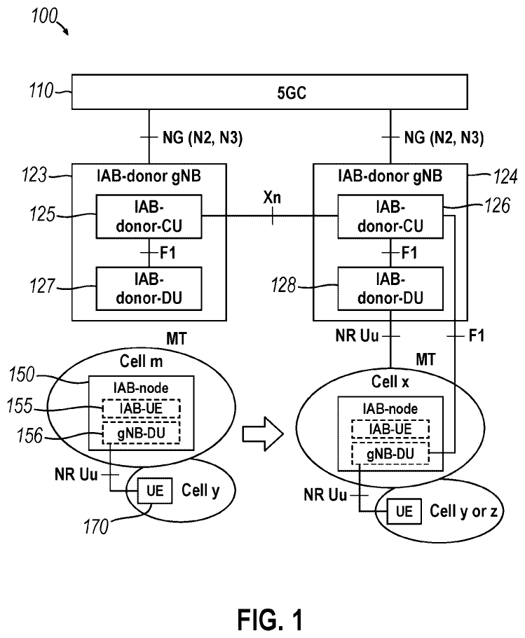

FIG. 1 shows one embodiment of a system 100 under the present disclosure. System 100 enables, among other functionalities, the mobility of IAB-node 150. IAB-node 150 moves together with connected UE(s) 170 which may undergo a possible cell ID change. This embodiment can be helpful for, at least, Key Issue 6. 5GC (5G Core) 110 is communicatively coupled to IAB-donor nodes (which could be IAB-donors or gNBs) 123 and 124. IAB-donor nodes 123, 124 comprise IAB-donor CUs 125, 126 and IAB-donor DUs (distributed units) 127, 128, respectively. IAB-node 150 comprises IAB-UE (IAB-MT) 155 and gNB-DU 156. IAB-node 150 is communicatively coupled to UE 170 over NR UU (the interface between UE and base station in New Radio). 5GC 110 is communicatively coupled to IAB-donor gNBs 123, 124 over NG (Next Generation, the interface between NG-RAN and 5GC). The interface between 5GC 110 and IAB-donors 123, 124 can be over e.g., N2 (control plane) and N3 (user plane). Connections between IAB-donor CU 125, 126 and IAB-donor DU 127, 128 (or gNB-DU 156) can be over F1 (the interface between a CU and DU in a gNB). Communications between IAB-donors 123 and 124 can be over Xn (the interface between gNBs in NR).

The embodiment of FIG. 1 can provide a way to represent the ULI of UE 170 connected to the mobile IAB-node 150 based on the location of the IAB-UE (alternatively an IAB-MT) 155. The IAB-UE 155 may move from IAB-donor 123 to IAB-donor 124. The ULI of the IAB-UE 155 corresponds to a geographic area. When the UEs (e.g., UE 170) connected to the IAB-node 150 are reconfigured to the new IAB-donor 124 (with the same or different cell/TAC/TAI (cell ID, tracking area code, tracking area identity) which is covered by the IAB-node 150 and managed by the new IAB-donor 124) the ULI of the IAB-UE 155 can be used to represent the ULI of the connected UE 170. This is in addition to the ULI of the connected UE 170, e.g., the cell y is considered as coverage extension of the cell x in FIG. 1. In FIG. 1, IAB-UE 155 could, for example, comprise a 5G-connected vehicle, like a car. Network 5GC 110 can track all connected UEs 170, but this can be difficult when IAB-UE 155 is mobile. IAB-UE 155 may move from cell m to cell x, for example, which in this example includes a move from IAB-donor 123 to IAB-donor 124. Tracking the location of UE 170 and/or cell y and/or cell z can require numerous information updates and onerous use of bandwidth and other resources. In embodiments of the current disclosure, IAB-donor 123 or 124 can report the location of IAB-UE 155 (e.g., cell m or cell x, as appropriate) to represent the ULI of any UE 170 connected to IAB-4 UE 155. The current ULI information on NGAP (NG Application Protocol) can be extended to support the additional ULI for UEs 170 connected to the IAB-node 150.

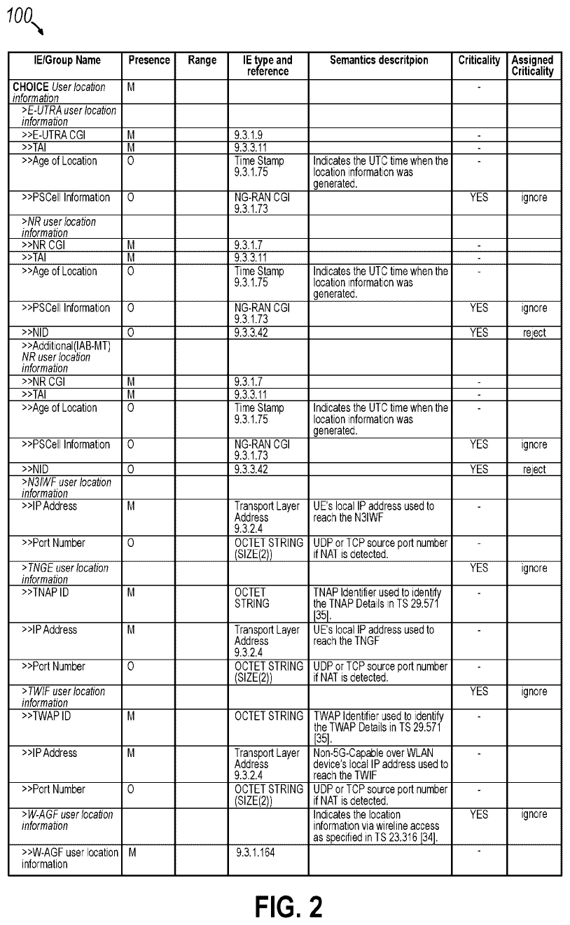

FIG. 2 sets forth a possible IE (information element) 200 that can be used to provide location information of the UE. When being implemented in embodiments of the present disclosure, several of the most important entries are from >Additional(IAB-MT) NR user location information down to >>NID.

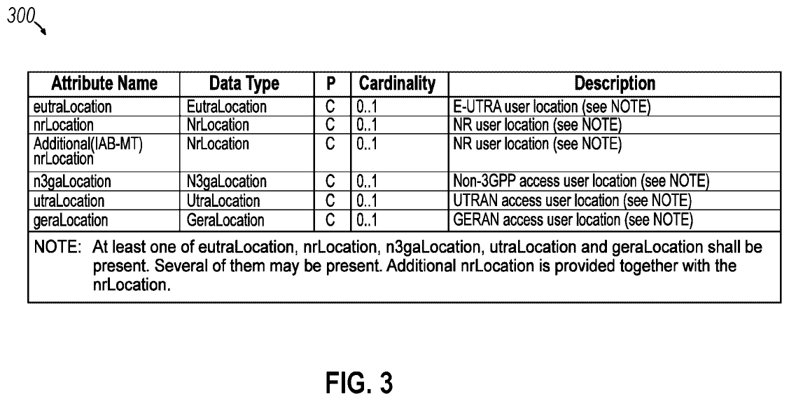

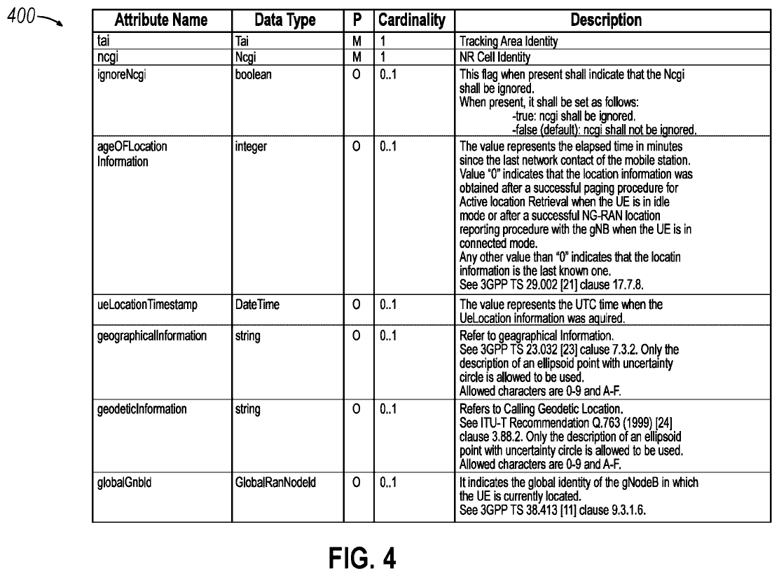

Regarding UserLocation, FIG. 3 gives a sample definition of the type UserLocation 300. Please note the field Additional(IAB-MT) nrLocation, which references NrLocation. Regarding NrLocation, FIG. 4 gives a sample definition of the type NrLocation 400.

For embodiments under the present disclosure, impacts on services, entities and interfaces can include the following. For AMF, additional ULI can be supported on top of current ULI and provide it to other NFs. For gNB, there can be support for the formulation of additional ULI for UE connected to IAB-node on top of current ULI.

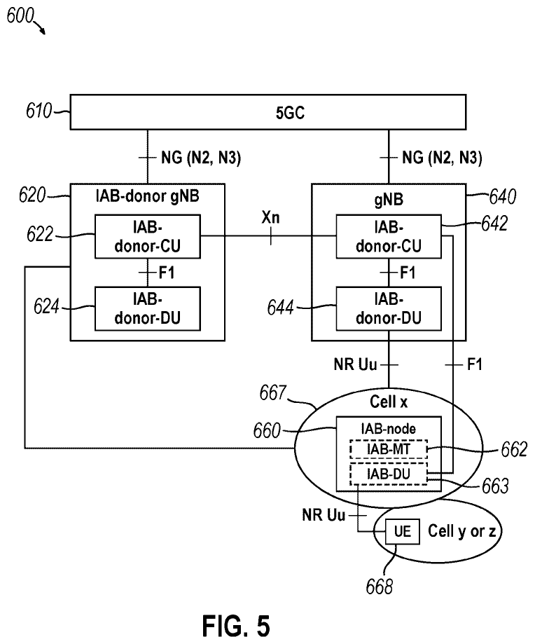

Embodiments under the present disclosure may include dual-connected RAN nodes (e.g., IAB-donor or gNB). FIG. 5 shows such a possible system embodiment 600. Other disclosed embodiments include those situations where the same IAB-donor is the MN (master node) of the IAB-MT and can hold the UE context, i.e., terminates the FI connection of the IAB-DU serving the UE.

Referring again to FIG. 5, a dual-connected embodiment can enable, for example, the functionality wherein the IAB-node (donor or gNB) 620 serving the UE 668 (i.e., terminating the FI connection of the IAB-DU 624 serving the UE) and the MN of the IAB-MT 662 are two different IAB-nodes (e.g., IAB-donor 620 and gNB 640). In a dual-connected embodiment, the UE can be controlled by e.g., IAB-donor 620 (e.g., IAB-donor 620 terminates the FI connection towards the collocated IAB-DU 663 serving the UE), whereas new information included in the NGAP message by IAB-donor 620 pertains to the cell x 667 (in this case) controlled by gNB 640.

Several different dual-connected embodiments are possible. In one case, the F1 connection of an IAB-DU 663 is terminated at the donor that acts as the MN of the collocated IAB-MT 662. In another case, the F1 connection of the IAB-DU 663 is terminated at the donor that acts as the SN (servant node) of the collocated IAB-MT 662. In these embodiments, any RAN node can be used, e.g., either an IAB-donor or a gNB, although both nodes cannot be a gNB. At least one should be an IAB-donor. In each case, the UEs 668 are served by the IAB-DU 663 part of the serving IAB node 660.

In the first case, the same node controls both the IAB-DU 663 cell (here, cell y or z) that the UE is connected to, and the cell x 667 that serves the collocated IAB-MT 662 (similar to the embodiments described above).

In the second case, the IAB-DU 663 that the UE 668 is connected to, and the cell x 667 that serves the collocated IAB-MT 662 are controlled by different donors. Under current specifications, the ULI for the UE 668 is reported to the core network 610 via NG by the RAN node that contains the UE context (i.e., the SN of the IAB-MT). In this second case embodiment, the SN can include in the NGAP message “Additional (IAB-MT) NR user location information,” which it can obtain from the MN by existing or newly introduced mechanisms (e.g., by means of a newly introduced or an enhanced existing XnAP procedure, or via the OAM, etc.).

In some embodiments, the existing “NR user location information” and the newly introduced “Additional (IAB-MT) NR user location information” are mutually exclusive choices, i.e., either of them is included in the message, but not both. In an alternative embodiment, they are both included in the message.

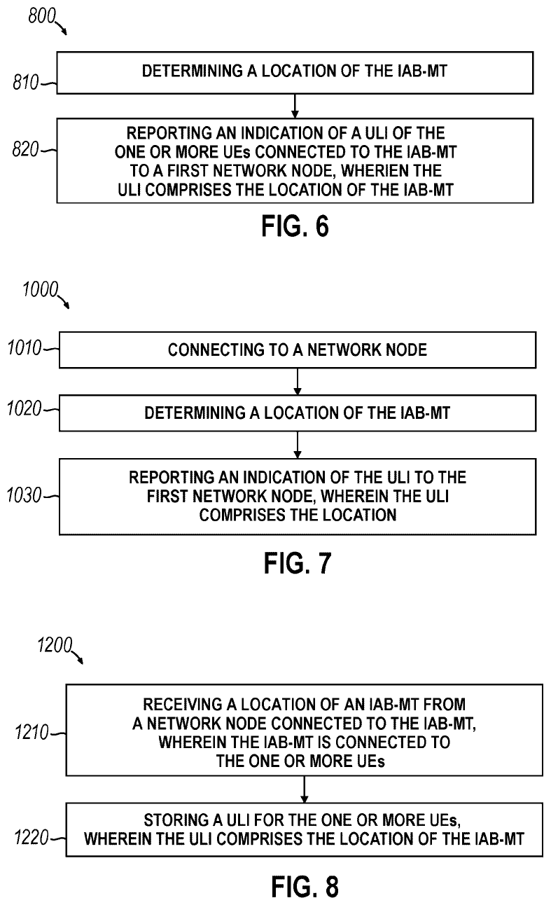

FIG. 6 displays an exemplary method embodiment. Method 800 is a method performed by an IAB donor for reporting ULI of UEs connected to an IAB-MT that is connected to the IAB donor. Step 810 is determining a location of the IAB-MT. Step 820 is reporting an indication of a ULI of the one or more UEs, connected to the IAB-MT, to a first network node, wherein the ULI comprises the location of the IAB-MT.

Method 800 can comprise multiple variations and a variety of additional or alternative steps. In some embodiments, determining the location of the IAB-MT comprises determining a first location of a first cell serving the IAB-MT. Some embodiments can further comprise determining a second location of a second cell serving the one or more UEs. In some cases, the first location and/or second location are used to comprise at least a portion of the ULI. In some variations the first cell or second cell comprise one or more of: a cell ID; a TAI; or any other appropriate type of ID. In some embodiments of method 800 the one or more UEs remain in the same cell. In other embodiments the one or more UEs move to a new cell. In some cases, detecting that one or more UEs are connected to an IAB-MT comprises detecting that the IAB-MT has moved from a previous IAB-donor to the IAB donor. Some embodiments further comprise determining a UE location of the one or more connected UEs and wherein the UE location comprises at least a portion of the ULI. Some versions further comprise reconfiguring the one or more UEs to the IAB donor from a previous IAB donor. In some embodiments, the IAB-MT is dual connected to the IAB donor and a previous IAB donor. In some cases, the reporting is done via NGAP. In some embodiments, a second network node serving the one or more UEs and a MN of the IAB-MT comprise two different network nodes.

FIG. 7 displays another method under the present disclosure. Method 1000 is a method performed by an IAB-MT for reporting ULI of UEs. Step 1010 is detecting one or more UEs. Step 1020 is connecting to a first network node. Step 1030 is connecting to a second network node. Step 1040 is detecting a location of the IAB-MT. Step 1050 is reporting the location to the first network node or the second network node, wherein the location is used to comprise at least a portion of a ULI of the one or more UEs.

Method 1000 can comprise multiple variations and a variety of additional or alternative steps. In some embodiments, determining the location of the IAB-MT comprises determining a first location of a first cell serving the IAB-MT. In some embodiments, the method further comprises determining a second location of a second cell serving the one or more UEs. In some variations, the first location and/or second location are used to comprise at least a portion of the ULI. In some cases, the first cell or second cell comprise one or more of: a cell ID; and a TAI. In some embodiments, the one or more UEs remain in the same cell after the IAB-MT connects to the second network node. In some embodiments, the one or more UEs move to a new cell after the IAB-MT connects to the second network node. In some embodiments, the method also comprises determining a UE location of the one or more UEs and forwarding the UE location to the first network node or the second network node. Some embodiments further comprise receiving a UE location of the one or more UEs and forwarding the UE location to the first network node or the second network node. In some versions, the reporting is done via NGAP. In some embodiments, the IAB-MT is dual connected to the first network node and the second network node. In some variations, a network node serving the one or more UEs and a MN of the IAB-MT comprise two different network nodes. In some versions, an F1 connection of an IAB-DU is terminated at the MN of the IAB-MT. In some versions, an F1 connection of an IAB-DU is terminated at a SN of the IAB-MT. In some embodiments, the second network node comprises one or more of: an IAB donor; the MN; the SN; a previous IAB donor; a gNB. In some embodiments, the first network node comprises one or more of: an IAB donor; the MN; the SN; a previous IAB donor; a gNB.

FIG. 8 displays another embodiment of a method under the present disclosure. Method 1200 is a method performed by a core network for tracking ULI of one or more UEs. Step 1210 is receiving a location of an IAB-MT from a network node connected to the IAB-MT, wherein the IAB-MT is connected to the one or more UEs. Step 1220 is storing a ULI for the one or more UEs, wherein the ULI comprises the location of the IAB-MT.

Method 1200 can comprise multiple variations and a variety of additional or alternative steps. The method can further comprise one or more of: receiving a first location of a first cell serving the IAB-MT; receiving a second location of a second cell serving the UE connected to the IAB-MT; and using the first location and/or the second location to comprise at least a portion of the ULI. In some embodiments, the IAB-MT is dual connected to the network node and a second network node.

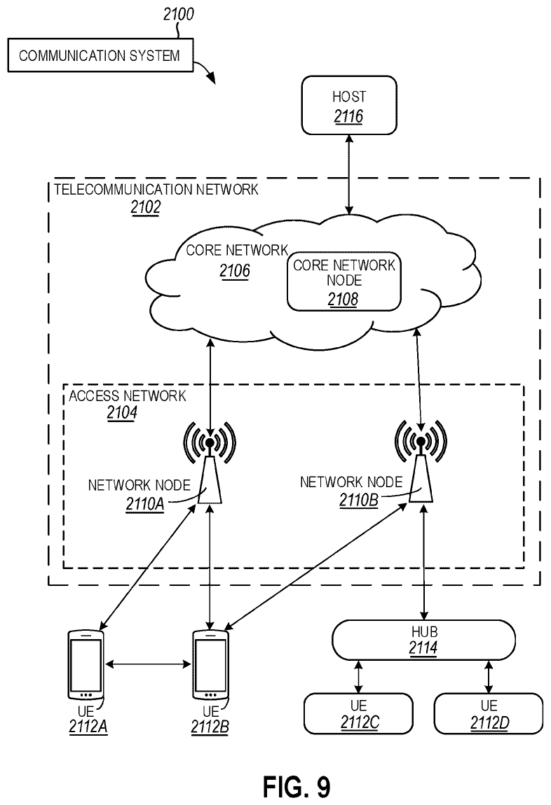

FIG. 9 shows an example of a communication system 2100 in accordance with some embodiments. In the example, the communication system 2100 includes a telecommunication network 2102 that includes an access network 2104, such as a RAN, and a core network 2106, which includes one or more core network nodes 2108. The access network 2104 includes one or more access network nodes, such as network nodes 2110a and 2110b (one or more of which may be generally referred to as network nodes 2110), or any other similar 3rd Generation Partnership Project (3GPP) access node or non-3GPP access point. The network nodes 2110 facilitate direct or indirect connection of UE, such as by connecting UEs 2112a, 2112b, 2112c, and 2112d (one or more of which may be generally referred to as UEs 2112) to the core network 2106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 2100 may include and/or interface with any type of communication, telecommunication, data, cellular, radio network, and/or other similar type of system.

The UEs 2112 may be any of a wide variety of communication devices, including wireless devices arranged, configured, and/or operable to communicate wirelessly with the network nodes 2110 and other communication devices. Similarly, the network nodes 2110 are arranged, capable, configured, and/or operable to communicate directly or indirectly with the UEs 2112 and/or with other network nodes or equipment in the telecommunication network 2102 to enable and/or provide network access, such as wireless network access, and/or to perform other functions, such as administration in the telecommunication network 2102.

In the depicted example, the core network 2106 connects the network nodes 2110 to one or more hosts, such as host 2116. These connections may be direct or indirect via one or more intermediary networks or devices. In other examples, network nodes may be directly coupled to hosts. The core network 2106 includes one more core network nodes (e.g., core network node 2108) that are structured with hardware and software components. Features of these components may be substantially similar to those described with respect to the UEs, network nodes, and/or hosts, such that the descriptions thereof are generally applicable to the corresponding components of the core network node 2108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2116 may be under the ownership or control of a service provider other than an operator or provider of the access network 2104 and/or the telecommunication network 2102, and may be operated by the service provider or on behalf of the service provider. The host 2116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2100 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2102 is a cellular network that implements 3GPP standardized features. Accordingly, the telecommunications network 2102 may support network slicing to provide different logical networks to different devices that are connected to the telecommunication network 2102. For example, the telecommunications network 2102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs. In some examples, the UEs 2112 are configured to transmit and/or receive information without direct human interaction. For instance, a UE may be designed to transmit information to the access network 2104 on a predetermined schedule, when triggered by an internal or external event, or in response to requests from the access network 2104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2114 communicates with the access network 2104 to facilitate indirect communication between one or more UEs (e.g., UE 2112c and/or 2112d) and network nodes (e.g., network node 2110b). In some examples, the hub 2114 may be a controller, router, content source and analytics, or any of the other communication devices described herein regarding UEs. For example, the hub 2114 may be a broadband router enabling access to the core network 2106 for the UEs. As another example, the hub 2114 may be a controller that sends commands or instructions to one or more actuators in the UEs. Commands or instructions may be received from the UEs, network nodes 2110, or by executable code, script, process, or other instructions in the hub 2114. As another example, the hub 2114 may be a data collector that acts as temporary storage for UE data and, in some embodiments, may perform analysis or other processing of the data. As another example, the hub 2114 may be a content source. For example, for a UE that is a VR headset, display, loudspeaker or other media delivery device, the hub 2114 may retrieve VR assets, video, audio, or other media or data related to sensory information via a network node, which the hub 2114 then provides to the UE either directly, after performing local processing, and/or after adding additional local content. In still another example, the hub 2114 acts as a proxy server or orchestrator for the UEs, in particular in if one or more of the UEs are low energy IoT devices.

The hub 2114 may have a constant/persistent or intermittent connection to the network node 2110b. The hub 2114 may also allow for a different communication scheme and/or schedule between the hub 2114 and UEs (e.g., UE 2112c and/or 2112d), and between the hub 2114 and the core network 2106. In other examples, the hub 2114 is connected to the core network 2106 and/or one or more UEs via a wired connection. Moreover, the hub 2114 may be configured to connect to an M2M service provider over the access network 1104 and/or to another UE over a direct connection. In some scenarios, UEs may establish a wireless connection with the network nodes 2110 while still connected via the hub 2114 via a wired or wireless connection. In some embodiments, the hub 2114 may be a dedicated hub-that is, a hub whose primary function is to route communications to/from the UEs from/to the network node 2110b. In an embodiment, the hub 2114 may be a non-dedicated hub-that is, a device which is capable of operating to route communications between the UEs and network node 2110b, but which is additionally capable of operating as a communication start and/or end point for certain data channels.

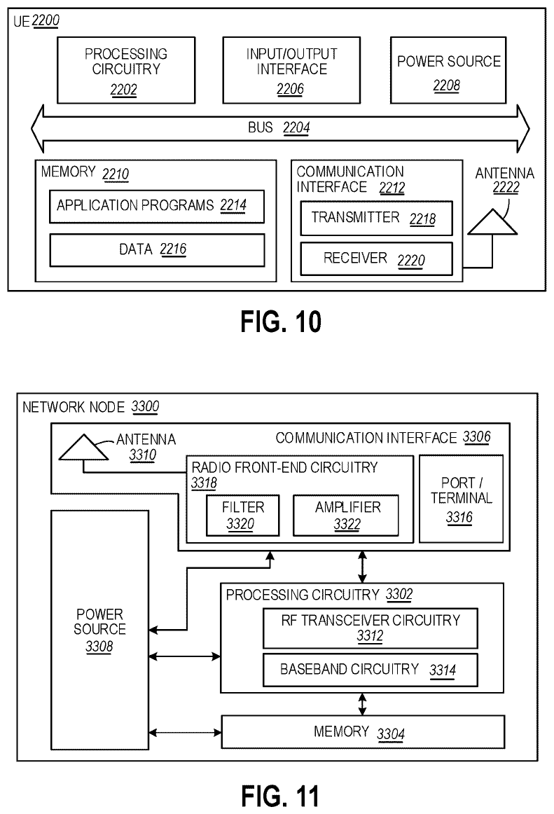

FIG. 10 shows a UE 2200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3GPP, including a narrow band internet of things (NB-IOT) UE, a machine type communication (MTC) UE, and/or an enhanced MTC (eMTC) UE.

A UE may support device-to-device (D2D) communication, e.g. by implementing a 3GPP standard for sidelink communication, Dedicated Short-Range Communication (DSRC), vehicle-to-vehicle (V2V), vehicle-to-infrastructure (V2I), or vehicle-to-everything (V2X).

The UE 2200 includes processing circuitry 2202 that is operatively coupled via a bus 2204 to an input/output interface 2206, a power source 2208, a memory 2210, a communication interface 2212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 2202 is configured to process instructions and data and may be configured to implement any sequential state machine operative to execute instructions stored as machine-readable computer programs in the memory 2210. The processing circuitry 2202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2202 may include multiple central processing units (CPUs).

In the example, the input/output interface 2206 may be configured to provide an interface or interfaces to an input device, output device, or one or more input and/or output devices.

In some embodiments, the power source 2208 is structured as a battery or battery pack. Other types of power sources, such as an external power source (e.g., an electricity outlet), photovoltaic device, or power cell, may be used. The power source 2208 may further include power circuitry for delivering power from the power source 2208 itself, and/or an external power source, to the various parts of the UE 2200 via input circuitry or an interface such as an electrical power cable. Delivering power may be, for example, for charging of the power source 2208. Power circuitry may perform any formatting, converting, or other modification to the power from the power source 2208 to make the power suitable for the respective components of the UE 2200 to which power is supplied.

The memory 2210 may be or be configured to include memory such as random access memory (RAM), read-only memory (ROM), programmable ROM (PROM), erasable PROM (EPROM), electrically EPROM (EEPROM), magnetic disks, optical disks, hard disks, removable cartridges, flash drives, and so forth. In one example, the memory 2210 includes one or more application programs 2214, such as an operating system, web browser application, a widget, gadget engine, or other application, and corresponding data 2216. The memory 2210 may store, for use by the UE 2200, any of a variety of various operating systems or combinations of operating systems.

The memory 2210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2210 may allow the UE 2200 to access instructions, application programs and the like, stored on transitory or non-transitory memory media, to off-load data, or to upload data. An article of manufacture, such as one utilizing a communication system may be tangibly embodied as or in the memory 2210, which may be or comprise a device-readable storage medium.

The processing circuitry 2202 may be configured to communicate with an access network or other network using the communication interface 2212. The communication interface 2212 may comprise one or more communication subsystems and may include or be communicatively coupled to an antenna 2222. The communication interface 2212 may include one or more transceivers used to communicate, such as by communicating with one or more remote transceivers of another device capable of wireless communication (e.g., another UE or a network node in an access network). Each transceiver may include a transmitter 2218 and/or a receiver 2220 appropriate to provide network communications (e.g., optical, electrical, frequency allocations, and so forth). Moreover, the transmitter 2218 and receiver 2220 may be coupled to one or more antennas (e.g., antenna 2222) and may share circuit components, software or firmware, or alternatively be implemented separately.

In the illustrated embodiment, communication functions of the communication interface 2212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, NR, UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of sensor types, a UE may provide an output of data captured by its sensors, through its communication interface 2212, via a wireless connection to a network node.

FIG. 11 shows a network node 3300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs (NBs), evolved NBs (eNBs) and NR NBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3300 includes a processing circuitry 3302, a memory 3304, a communication interface 3306, and a power source 3308. The network node 3300 may be composed of multiple physically separate components (e.g., a NodeB component and a RNC component, or a BTS component and a BSC component, etc.), which may each have their own respective components. In certain scenarios in which the network node 3300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 3304 for different RATs) and some components may be reused (e.g., a same antenna 3310 may be shared by different RATs). The network node 3300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 3302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3300 components, such as the memory 3304, to provide network node 3300 functionality.

In some embodiments, the processing circuitry 3302 includes a system on a chip (SOC). In some embodiments, the processing circuitry 3302 includes one or more of radio frequency (RF) transceiver circuitry 3312 and baseband processing circuitry 3314. In some embodiments, the radio frequency (RF) transceiver circuitry 3312 and the baseband processing circuitry 3314 may be on separate chips (or sets of chips), boards, or units, such as radio units and digital units. In alternative embodiments, part or all of RF transceiver circuitry 3312 and baseband processing circuitry 3314 may be on the same chip or set of chips, boards, or units. Processing circuitry 3302 can perform various methods and processes including embodiments of this disclosure, including methods 800, 1000, and/or 1200.

The memory 3304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3302. The memory 3304 may store any suitable instructions, data, or information, including a computer program, software, an application including one or more of logic, rules, code, tables, and/or other instructions capable of being executed by the processing circuitry 3302 and utilized by the network node 3300. The memory 3304 may be used to store any calculations made by the processing circuitry 3302 and/or any data received via the communication interface 3306. In some embodiments, the processing circuitry 3302 and memory 3304 is integrated.

The communication interface 3306 is used in wired or wireless communication of signaling and/or data between a network node, access network, and/or UE. As illustrated, the communication interface 3306 comprises port(s)/terminal(s) 3316 to send and receive data, for example to and from a network over a wired connection. The communication interface 3306 also includes radio front-end circuitry 3318 that may be coupled to, or in certain embodiments a part of, the antenna 3310. Radio front-end circuitry 3318 comprises filters 3320 and amplifiers 3322. The radio front-end circuitry 3318 may be connected to an antenna 3310 and processing circuitry 3302. The radio front-end circuitry may be configured to condition signals communicated between antenna 3310 and processing circuitry 3302. The radio front-end circuitry 3318 may receive digital data that is to be sent out to other network nodes or UEs via a wireless connection. The radio front-end circuitry 3318 may convert the digital data into a radio signal having the appropriate channel and bandwidth parameters using a combination of filters 3320 and/or amplifiers 3322. The radio signal may then be transmitted via the antenna 3310. Similarly, when receiving data, the antenna 3310 may collect radio signals which are then converted into digital data by the radio front-end circuitry 3318. The digital data may be passed to the processing circuitry 3302. In other embodiments, the communication interface may comprise different components and/or different combinations of components.

In certain alternative embodiments, the network node 3300 does not include separate radio front-end circuitry 3318, instead, the processing circuitry 3302 includes radio front-end circuitry and is connected to the antenna 3310. Similarly, in some embodiments, all or some of the RF transceiver circuitry 3312 is part of the communication interface 3306. In still other embodiments, the communication interface 3306 includes one or more ports or terminals 3316, the radio front-end circuitry 3318, and the RF transceiver circuitry 3312, as part of a radio unit (not shown), and the communication interface 3306 communicates with the baseband processing circuitry 3314, which is part of a digital unit (not shown).

The antenna 3310 may include one or more antennas, or antenna arrays, configured to send and/or receive wireless signals. The antenna 3310 may be coupled to the radio front-end circuitry 3318 and may be any type of antenna capable of transmitting and receiving data and/or signals wirelessly. In certain embodiments, the antenna 3310 is separate from the network node 3300 and connectable to the network node 3300 through an interface or port.

The antenna 3310, communication interface 3306, and/or the processing circuitry 3302 may be configured to perform any receiving operations and/or certain obtaining operations described herein as being performed by the network node. Any information, data and/or signals may be received from a UE, another network node and/or any other network equipment. Similarly, the antenna 3310, the communication interface 3306, and/or the processing circuitry 3302 may be configured to perform any transmitting operations described herein as being performed by the network node. Any information, data and/or signals may be transmitted to a UE, another network node and/or any other network equipment.

The power source 3308 provides power to the various components of network node 3300 in a form suitable for the respective components (e.g., at a voltage and current level needed for each respective component). The power source 3308 may further comprise, or be coupled to, power management circuitry to supply the components of the network node 3300 with power for performing the functionality described herein. For example, the network node 3300 may be connectable to an external power source (e.g., the power grid, an electricity outlet) via an input circuitry or interface such as an electrical cable, whereby the external power source supplies power to power circuitry of the power source 3308. As an example, the power source 3308 may comprise a source of power in the form of a battery or battery pack which is connected to, or integrated in, power circuitry. The battery may provide backup power should the external power source fail.

Embodiments of the network node 3300 may include additional components beyond those shown in FIG. 11 for providing certain aspects of the network node's functionality, including any of the functionality described herein and/or any functionality necessary to support the subject matter described herein. For example, the network node 3300 may include user interface equipment to allow input of information into the network node 3300 and to allow output of information from the network node 3300. This may allow a user to perform diagnostic, maintenance, repair, and other administrative functions for the network node 3300.

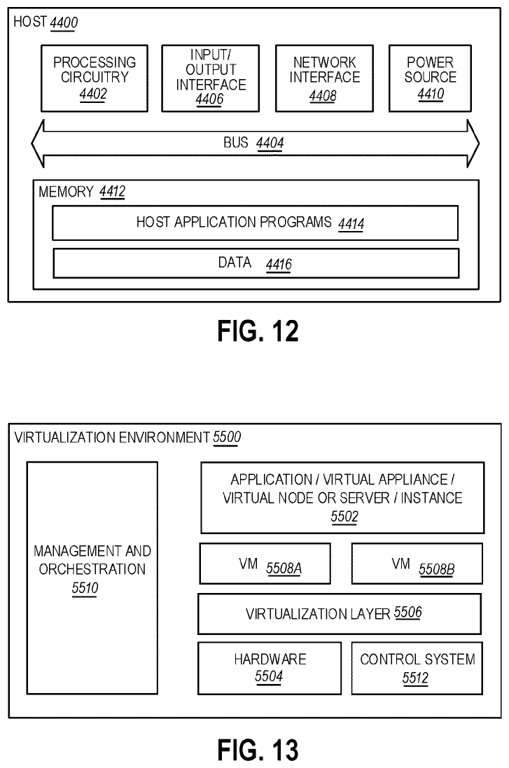

FIG. 12 is a block diagram of a host 4400, which may be an embodiment of the host 2116 of FIG. 9, in accordance with various aspects described herein. As used herein, the host 4400 may be or comprise various combinations hardware and/or software, including a standalone server, a blade server, a cloud-implemented server, a distributed server, a virtual machine, container, or processing resources in a server farm. The host 4400 may provide one or more services to one or more UEs.

The host 4400 includes processing circuitry 4402 that is operatively coupled via a bus 4404 to an input/output interface 4406, a network interface 4408, a power source 4410, and a memory 4412. Other components may be included in other embodiments. Features of these components may be substantially similar to those described with respect to the devices of previous figures, such as FIGS. 10 and 11, such that the descriptions thereof are generally applicable to the corresponding components of host 4400.

The memory 4412 may include one or more computer programs including one or more host application programs 4414 and data 4416, which may include user data, e.g., data generated by a UE for the host 4400 or data generated by the host 4400 for a UE. Embodiments of the host 4400 may utilize only a subset or all of the components shown. The host application programs 4414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 4414 may also provide for user authentication and licensing checks and may periodically report health, routes, and content availability to a central node, such as a device in or on the edge of a core network. Accordingly, the host 4400 may select and/or indicate a different host for over-the-top services for a UE. The host application programs 4414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 5500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 5500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 5502 (which may alternatively be called software instances, virtual appliances, network functions, virtual nodes, virtual network functions, etc.) are run in the virtualization environment 5500 to implement some of the features, functions, and/or benefits of some of the embodiments disclosed herein.

Hardware 5504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 5506 (also referred to as hypervisors or virtual machine monitors (VMMs)), provide VMs 5508a and 5508b (one or more of which may be generally referred to as VMs 5508), and/or perform any of the functions, features and/or benefits described in relation with some embodiments described herein. The virtualization layer 5506 may present a virtual operating platform that appears like networking hardware to the VMs 5508.

The VMs 5508 comprise virtual processing, virtual memory, virtual networking or interface and virtual storage, and may be run by a corresponding virtualization layer 5506. Different embodiments of the instance of a virtual appliance 5502 may be implemented on one or more of VMs 5508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 5508 may be a software implementation of a physical machine that runs programs as if they were executing on a physical, non-virtualized machine. Each of the VMs 5508, and that part of hardware 5504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 5508 on top of the hardware 5504 and corresponds to the application 5502.

Hardware 5504 may be implemented in a standalone network node with generic or specific components. Hardware 5504 may implement some functions via virtualization. Alternatively, hardware 5504 may be part of a larger cluster of hardware (e.g., such as in a data center or CPE) where many hardware nodes work together and are managed via management and orchestration 5510, which, among others, oversees lifecycle management of applications 5502. In some embodiments, hardware 5504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 5512 which may alternatively be used for communication between hardware nodes and radio units.

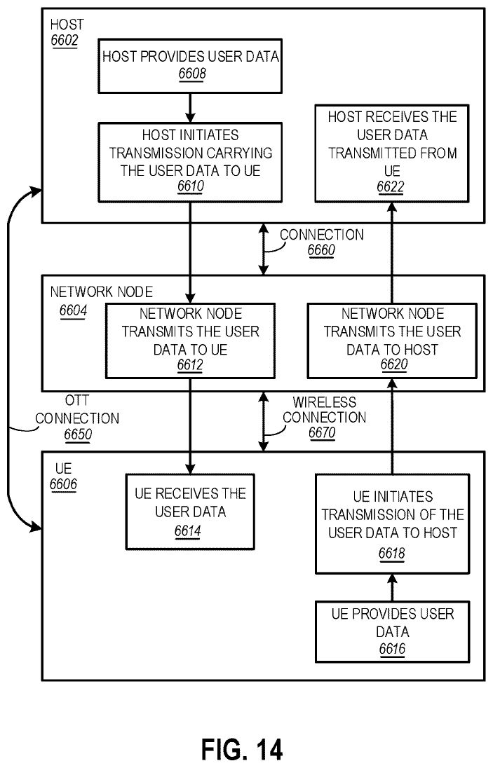

FIG. 14 shows a communication diagram of a host 6602 communicating via a network node 6604 with a UE 6606 over a partially wireless connection in accordance with some embodiments. Example implementations, in accordance with various embodiments, of the UE (such as a UE 2112a of FIG. 9 and/or UE 2200 of FIG. 10), network node (such as network node 2110a of FIG. 9 and/or network node 3300 of FIG. 11), and host (such as host 2116 of FIG. 9 and/or host 4400 of FIG. 12) discussed in the preceding paragraphs will now be described with reference to FIG. 14.

Like host 4400, embodiments of host 6602 include hardware, such as a communication interface, processing circuitry, and memory. The host 6602 also includes software, which is stored in or accessible by the host 6602 and executable by the processing circuitry. The software includes a host application that may be operable to provide a service to a remote user, such as the UE 6606 connecting via an over-the-top (OTT) connection 6650 extending between the UE 6606 and host 6602. In providing the service to the remote user, a host application may provide user data which is transmitted using the OTT connection 6650.

The network node 6604 includes hardware enabling it to communicate with the host 6602 and UE 6606. The connection 6660 may be direct or pass through a core network (like core network 2106 of FIG. 9) and/or one or more other intermediate networks, such as one or more public, private, or hosted networks. For example, an intermediate network may be a backbone network or the Internet.

The UE 6606 includes hardware and software, which is stored in or accessible by UE 6606 and executable by the UE's processing circuitry. The software includes a client application, such as a web browser or operator-specific “app” that may be operable to provide a service to a human or non-human user via UE 6606 with the support of the host 6602. In the host 6602, an executing host application may communicate with the executing client application via the OTT connection 6650 terminating at the UE 6606 and host 6602. In providing the service to the user, the UE's client application may receive request data from the host's host application and provide user data in response to the request data. The OTT connection 6650 may transfer both the request data and the user data. The UE's client application may interact with the user to generate the user data that it provides to the host application through the OTT connection 6650. The OTT connection 6650 may extend via a connection 6660 between the host 6602 and the network node 6604 and via a wireless connection 6670 between the network node 6604 and the UE 6606 to provide the connection between the host 6602 and the UE 6606. The connection 6660 and wireless connection 6670, over which the OTT connection 6650 may be provided, have been drawn abstractly to illustrate the communication between the host 6602 and the UE 1606 via the network node 6604, without explicit reference to any intermediary devices and the precise routing of messages via these devices.

As an example of transmitting data via the OTT connection 6650, in step 6608, the host 6602 provides user data, which may be performed by executing a host application. In some embodiments, the user data is associated with a particular human user interacting with the UE 6606. In other embodiments, the user data is associated with a UE 6606 that shares data with the host 6602 without explicit human interaction. In step 6610, the host 6602 initiates a transmission carrying the user data towards the UE 6606. The host 6602 may initiate the transmission responsive to a request transmitted by the UE 6606. The request may be caused by human interaction with the UE 6606 or by operation of the client application executing on the UE 6606. The transmission may pass via the network node 6604, in accordance with the teachings of the embodiments described throughout this disclosure. Accordingly, in step 6612, the network node 6604 transmits to the UE 6606 the user data that was carried in the transmission that the host 6602 initiated, in accordance with the teachings of the embodiments described throughout this disclosure. In step 6614, the UE 6606 receives the user data carried in the transmission, which may be performed by a client application executed on the UE 6606 associated with the host application executed by the host 6602.

In some examples, the UE 6606 executes a client application which provides user data to the host 6602. The user data may be provided in reaction or response to the data received from the host 6602. Accordingly, in step 6616, the UE 6606 may provide user data, which may be performed by executing the client application. In providing the user data, the client application may further consider user input received from the user via an input/output interface of the UE 6606. Regardless of the specific manner in which the user data was provided, the UE 6606 initiates, in step 6618, transmission of the user data towards the host 6602 via the network node 6604. In step 6620, in accordance with the teachings of the embodiments described throughout this disclosure, the network node 6604 receives user data from the UE 6606 and initiates transmission of the received user data towards the host 6602. In step 6622, the host 6602 receives the user data carried in the transmission initiated by the UE 6606.

One or more of the various embodiments improve the performance of OTT services provided to the UE 6606 using the OTT connection 6650, in which the wireless connection 6670 forms the last segment. More precisely, the teachings of these embodiments may improve the data rate, latency, and/or power consumption and thereby provide benefits such as reduced user waiting time, relaxed restriction on file size, improved content resolution, better responsiveness, and/or extended battery lifetime.

In an example scenario, factory status information may be collected and analyzed by the host 6602. As another example, the host 6602 may process audio and video data which may have been retrieved from a UE for use in creating maps. As another example, the host 6602 may collect and analyze real-time data to assist in controlling vehicle congestion (e.g., controlling traffic lights). As another example, the host 6602 may store surveillance video uploaded by a UE. As another example, the host 6602 may store or control access to media content such as video, audio, VR or AR which it can broadcast, multicast or unicast to UEs. As other examples, the host 6602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 6650 between the host 6602 and UE 6606, in response to variations in the measurement results. The measurement procedure and/or the network functionality for reconfiguring the OTT connection may be implemented in software and hardware of the host 6602 and/or UE 6606. In some embodiments, sensors (not shown) may be deployed in or in association with other devices through which the OTT connection 6650 passes; the sensors may participate in the measurement procedure by supplying values of the monitored quantities exemplified above, or supplying values of other physical quantities from which software may compute or estimate the monitored quantities. The reconfiguring of the OTT connection 6650 may include message format, retransmission settings, preferred routing etc. ; the reconfiguring need not directly alter the operation of the network node 6604. Such procedures and functionalities may be known and practiced in the art. In certain embodiments, measurements may involve proprietary UE signaling that facilitates measurements of throughput, propagation times, latency and the like, by the host 6602. The measurements may be implemented in that software causes messages to be transmitted, in particular empty or ‘dummy’ messages, using the OTT connection 6650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

The above-described embodiments are examples only. Alterations, modifications, and variations may be effected to the particular embodiments by those of skill in the art without departing from the scope of the description, which is defined solely by the appended claims.

1. A method performed by an Integrated Access and Backhaul (IAB) donor for reporting User Location Information (ULI) of user equipments (UEs) connected to an IAB Mobile Termination (IAB-MT) that is connected to the IAB donor, the method comprising:
determining a location of the IAB-MT; and
reporting an indication of ULI of the one or more UEs, connected to the IAB-MT, to a first network node wherein the ULI comprises the location of the IAB-MT.

2. The method of claim 1, wherein the indication comprises the ULI.

3. The method of claim 1, wherein determining the location of the IAB-MT comprises determining a first location of a first cell serving the IAB-MT.

4. The method of claim 1, further comprising determining a second location of a second cell serving the one or more UEs.

5. The method of claim 3, wherein the ULI comprises at least one of:
the first location; and the second location; a New Radio Cell Identity (NR CGI); Tracking Area Identity (TAI); Age of Location; Primary Serving Cell (PSCell) Information; Network Identifier (NID).

6. The method of claim 3, wherein the first cell or second cell comprise one or more of: a cell identifier (cell ID); and a tracking area identity (TAI).

7. The method of claim 1, wherein the one or more UEs remain in the same cell.

8. The method of claim 1, wherein the one or more UEs move to a new cell.

9-13. (canceled)

14. A method performed by an Integrated Access and Backhaul Mobile Termination (IAB-MT) for reporting User Location Information (ULI) of user equipments (UEs) the method comprising:
connecting to a first network node;
determining a location of the IAB-MT; and
reporting an indication of ULI to the first network node, wherein the ULI comprises the location.

15. (canceled)

16. The method of claim 14, further comprising connecting to a second network node and reporting the indication of ULI to the first network node or the second network node.

17. The method of claim 14, wherein the indication comprises the ULI.

18. The method of claim 14, wherein determining the location of the IAB-MT comprises determining a first location of a first cell serving the IAB-MT.

19. The method of claim 14, further comprising determining a second location of a second cell serving the one or more UEs.

20. The method of claim 18, wherein the ULI comprises one or more of:
the first location; and the second location; a New Radio Cell Identity (NR CGI); Tracking Area Identity (TAI); Age of Location; Primary Serving Cell (PSCell) Information; Network Identifier (NID).

21-25. (canceled)

26. The method of claim 14, wherein the reporting is done via at least one of: Next Generation Application Protocol (NGAP); a Next Generation Uu interface; an Xn Application Protocol (XnAP) procedure; via an Operations and Management (OAM); over an F1 connection.

27-30. (canceled)

31. A network node for reporting and/or tracking User Location Information of one or more user equipments (UEs), the network node comprising:
processing circuitry configured to perform the steps of;
determining a location of an Integrated Access and Backhaul Mobile Termination (IAB-MT) connected to the one or more UEs; and
reporting an indication of ULI of the one or more UEs, connected to the IAB-MT, to a first network node, wherein the ULI comprises the location of the IAB-MT; and
power supply circuitry configured to supply power to the processing circuitry.

32. The network node of claim 31, wherein the indication comprises the ULI.

33. The network node of claim 31, wherein determining the location of the IAB-MT comprises determining a first location of a first cell serving the IAB-MT.

34. The network node of claim 31, wherein the network node comprises at least one of: an IAB-donor; the IAB-MT.

35. The method of claim 1, wherein the reporting is done via Next Generation Application Protocol (NGAP).
